(19) United States
(12) Patent Application Publication
(10) Pub. No.: US 2009/0128644 A1
(43) Pub. Date: May 21, 2009

(54) SYSTEM AND METHOD FOR GENERATING A PHOTOGRAPH

(76) Inventors: William O. Camp, JR., Chapel Hill, NC (US); Mark G. Kokes, Raleigh, NC (US); Toby J. Bowen, Durham, NC (US); Walter M. Marcinkiewicz, Chapel Hill, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/940,849

(22) Filed: Nov. 15, 2007

(51) Int. Cl. H04N 9/73; H04N 7/00; H04N 5/225; H04N 5/262

(52) U.S. Cl. 348/218.1; 348/240.99

(57) ABSTRACT

Generating a photograph with a digital camera may include capturing a first image of a scene with a first zoom setting and capturing a second image of the scene with a second zoom setting, where the second zoom setting corresponds to higher magnification than the first zoom setting. The second image may be stitched into the first image in place of a removed portion of the first image that corresponds to a portion of the scene represented by the second image. The result is the photograph, which has a region corresponding to image data of the second image and a region corresponding to image data of the first image.

### TECHNICAL FIELD OF THE INVENTION

The technology of the present disclosure relates generally to photography and, more particularly, to a system and method for combining multiple images of a scene that are taken with different amounts of magnification to establish a photograph.

### BACKGROUND

Mobile and/or wireless electronic devices are becoming increasingly popular. For example, mobile telephones, portable media players and portable gaming devices are now in wide-spread use. In addition, the features associated with certain types of electronic devices have become increasingly diverse. For example, many mobile telephones now include cameras that are capable of capturing still images and video images.

The imaging devices associated with many portable electronic devices are becoming easier to use and are capable of taking reasonably high-quality photographs. As a result, users are taking more photographs, which has caused an increased demand for data storage capacity of a memory of the electronic device. Raw image data captured by the imaging device is often compressed so that an associated image file does not take up an excessively large amount of memory. But conventional compression techniques are applied uniformly across the entire image without regard to which portion of the image may be of the highest interest to the user.

### SUMMARY

The present disclosure describes a system and method of generating a photograph that has varying degrees of quality across the photograph. The photograph may be generated by taking two or more images of a scene with different zoom settings. The images are merged to create the photograph. For instance, an image taken with relatively high zoom is inset into an image taken with less zoom by replacing the portion of the low zoom image that corresponds to the portion of the scene containing the subject matter of the high zoom image with that high zoom image.

In one embodiment, the image taken with low zoom is up-sampled to allow for registration of the image data of the high zoom image with the image data of the low zoom image. In this embodiment, the image taken with high zoom will have a higher density of image information per unit area of the scene than the image taken with low zoom. Therefore, the high zoom image has a higher perceptual quality for its portion of the scene than the corresponding portion of the scene as represented by the low zoom image. In this manner, a photograph with a quality differential across the photograph may be generated.

It will be recognized that more than two images taken with progressively increasing (or decreasing) zoom may be used to generate a photograph that has progressively changing quality across the photograph. Also, the composite photograph may be compressed and/or down-sampled using conventional techniques that uniformly compress and/or down-sample the image data.

In some embodiments, the size of an image file for the photograph (e.g., in number of bytes) may be lower than a conventionally captured and compressed image for same scene. This may result in conserving memory space. But even though the average file size of image files for photographs that are generated in the disclosed manner may be reduced compared to conventionally generated image files, the details of the photograph that are likely to be of importance to the user may be retained with relatively high image quality.

According to one aspect of the disclosure, a method of generating a photograph with a digital camera includes capturing a first image of a scene with a first zoom setting; capturing a second image of the scene with a second zoom setting, the second zoom setting corresponding to higher magnification than the first zoom setting; up-sampling the first image to generate an interim image; and stitching the second image into the interim image in place of a removed portion of the interim image that corresponds to a portion of the scene represented by the second image such that the stitched image is the photograph, the photograph having higher perceptual quality in a region corresponding to image data of the second image than in a region corresponding to image data of the first image.

According to an embodiment of the method, the first image corresponds to a field of view of the camera that is composed by a user of the camera.

According to an embodiment of the method, up-sampling of the first image includes filtering image data of the first image.

According to an embodiment of the method, the first image and the second image have substantially the same center spot with respect to the scene.

According to an embodiment of the method, a center spot of the second image is shifted with respect to a center spot of the first image.

According to an embodiment, the method further includes using pattern recognition to identify an object in the scene and the center spot of the second image is centered on the object.

According to an embodiment of the method, the recognized object is a face.

According to an embodiment of the method, the first and the second images are captured in rapid succession to minimize changes in the scene between capturing the first image and capturing the second image.

According to an embodiment, the method further includes capturing at least one additional image, where each additional image is captured with a zoom setting different than the first zoom setting; and combining each additional image with the first and second images so that the photograph has quality regions that correspond to image data from each image.

According to an embodiment of the method, each image has substantially the same center spot with respect to the scene.

According to an embodiment of the method, the zoom setting associated with each image is different than every other zoom setting.

According to an embodiment of the method, at least two of the images have corresponding center spots that differ from the rest of the images.

According to another aspect of the disclosure, a camera assembly for generating a digital photograph includes a sensor for capturing image data; imaging optics for focusing light from a scene onto the sensor, the imaging optics being adjustable to change a zoom setting of the camera assembly; and a controller that controls the sensor and the imaging optics to capture a first image of a scene with a first zoom setting and a second image of the scene with a second zoom setting, the second zoom setting corresponding to higher magnification than the first zoom setting, wherein the controller up-samples the first image; and stitches the second image into the interim image in place of a removed portion of the interim image that corresponds to a portion of the scene represented by the second image such that the stitched image is the photograph, the photograph having higher perceptual quality in a region corresponding to image data of the second image than in a region corresponding to image data of the first image.

According to an embodiment of the camera assembly, the first image corresponds to a field of view of the camera assembly that is composed by a user of the camera assembly.

According to an embodiment of the camera assembly, up-sampling of the first image includes filtering image data of the first image.

According to an embodiment of the camera assembly, the first image and the second image have substantially the same center spot with respect to the scene.

According to an embodiment of the camera assembly, a center spot of the second image is shifted with respect to a center spot of the first image.

According to an embodiment of the camera assembly, pattern recognition is used to identify an object in the scene and the center spot of the second image is centered on the object.

According to an embodiment of the camera assembly, the first and the second images are captured in rapid succession to minimize changes in the scene between capturing the first image and capturing the second image.

According to an embodiment of the camera assembly, the controller controls the sensor to capture at least one additional image, where each additional image is captured with a zoom setting different than the first zoom setting and the controller combines each additional image with the first and second images so that the photograph has quality regions that correspond to image data from each image.

According to an embodiment of the camera assembly, the camera assembly forms part of a mobile telephone that establishes a call over a network.

According to another aspect of the disclosure, a method of generating a photograph with a digital camera includes capturing a first image of a scene with a first zoom setting; capturing a second image of the scene with a second zoom setting, the second zoom setting corresponding to higher magnification than the first zoom setting; down-sampling the second image to generate an interim image; and stitching the interim image into the first image in place of a removed portion of the first image that corresponds to a portion of the scene represented by the interim image such that the stitched image is the photograph, the photograph having higher quality as a function of peak signal-to-noise ratio than the first image.

According to one embodiment of the method, the first image corresponds to a field of view of the camera that is composed by a user of the camera.

According to one embodiment of the method, down-sampling of the second image includes filtering image data of the second image.

According to one embodiment, the method further includes capturing at least one additional image, where each additional image is captured with a zoom setting different than the first zoom setting; and combining each additional image with the first and second images so that the photograph has regions that correspond to image data from each image.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIGS. 1 and 2 are respectively a front view and a rear view of an exemplary electronic device that includes a representative camera assembly;

FIG. 3 is a schematic block diagram of the electronic device of FIGS. 1 and 2;

FIG. 4 is a schematic diagram of a communications system in which the electronic device of FIGS. 1 and 2 may operate;

FIG. 5 is a schematic depiction of a scene and a camera assembly that is configured to capture an image of the scene with a first zoom setting;

FIG. 6 is a schematic depiction of the scene and the camera assembly of FIG. 5 with the camera assembly configured to capture an image of the scene with a second zoom setting;

FIG. 7 is a schematic depiction of an exemplary technique for generating a photograph of a scene from multiple images of the scene that are taken with different zoom settings; and

FIG. 8 is a schematic depiction of a photograph that has been generated by combining multiple images of a scene that are taken with different zoom settings.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of a system and a method for generating a photograph. In the illustrated embodiments, the photograph generation is carried out by a device that includes a digital camera assembly used to capture image data in the form of still images. It will be understood that the image data may be captured by one device and then transferred to another device that carries out the photograph generation. It also will be understood that the camera assembly may be capable of capturing video images in addition to still images.

The photograph generation will be primarily described in the context of processing image data captured by a digital camera that is made part of a mobile telephone. It will be appreciated that the photograph generation may be carried out in other operational contexts such as, but not limited to, a dedicated camera or another type of electronic device that has a camera (e.g., a personal digital assistant (PDA), a media player, a gaming device, a “web” camera, a computer, etc.). Also, the photograph generation may be carried out by a device that processes existing image data, such as by a computer that accesses stored image data from a data storage medium or that receives image data over a communication link.

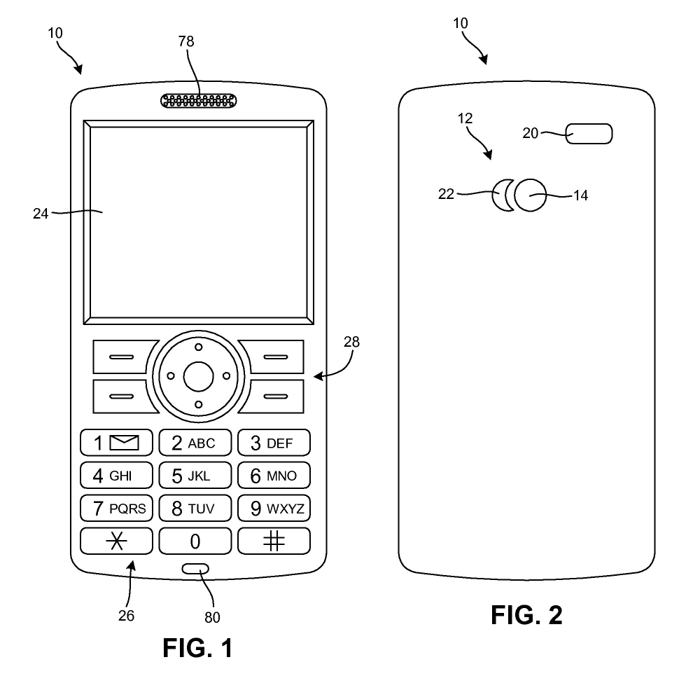

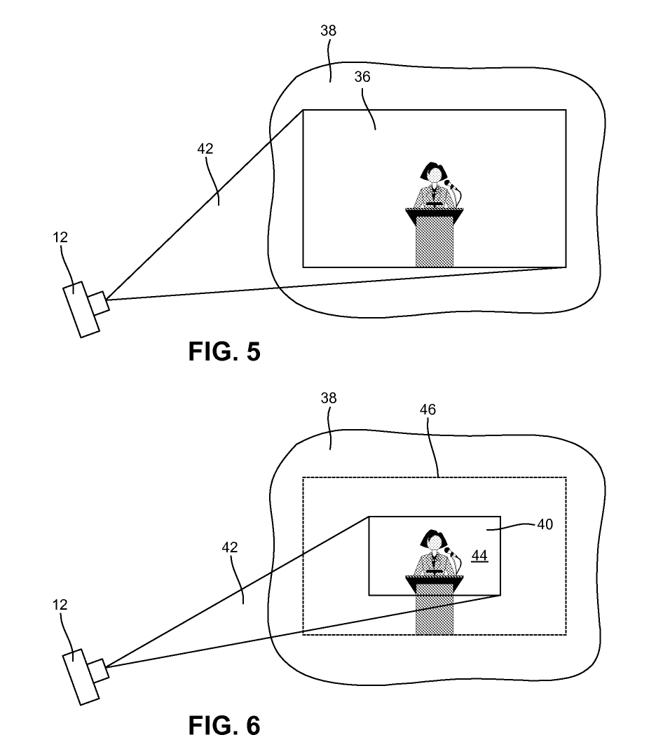

Referring initially to FIGS. 1 and 2, an electronic device 10 is shown. The illustrated electronic device 10 is a mobile telephone. The electronic device 10 includes a camera assembly 12 for taking digital still pictures and/or digital video clips. It is emphasized that the electronic device 10 need not be a mobile telephone, but could be a dedicated camera or some other device as indicated above. For instance, as illustrated in FIGS. 5 and 6, the electronic device 10 is a dedicated camera assembly 12.

With reference to FIGS. 1 through 3, the camera assembly 12 may be arranged as a typical camera assembly that includes imaging optics 14 to focus light from a scene within the field of view of the camera assembly 12 onto a sensor 16. The sensor 16 converts the incident light into image data that may be processed using the techniques described in this disclosure. The imaging optics 14 may include a lens assembly and components that that supplement the lens assembly, such as a protective window, a filter, a prism, a mirror, focusing mechanics, and focusing control electronics (e.g., a multi-zone autofocus assembly).

The camera assembly 12 may further include a mechanical zoom assembly 18. The mechanical zoom assembly 18 may include a driven mechanism to move one of more of the elements that make up the imaging optics 14 to change the magnification of the camera assembly 12. It is possible that the zoom assembly 18 also moves the sensor 16. The zoom assembly 18 may be capable of establishing multiple magnification levels and, for each magnification level, the imaging optics 14 will have a corresponding focal length. Also, the field of view of the camera assembly 12 will decrease as the magnification level increases. The zoom assembly 18 may be capable of infinite magnification settings between a minimum setting and a maximum setting, or may be arranged to have discrete magnification steps ranging from a minimum setting to a maximum setting. The mechanical zoom assembly 18 of the illustrated embodiments optically changes the magnification power of the camera assembly 12 by moving components along the optical axis of the camera assembly 12. Other techniques to change the optical zoom may be possible. For instance, one or more stationary lenses may be changed in shape in response to an input electrical signal to effectuate changes in zoom. In one embodiment, a liquid lens (e.g., a liquid filled member that has flexible walls) may be changed in shape to impart different focal lengths to the optical pathway. In this embodiment, a small amount of mass may be moved when changing focal lengths and, therefore, the propensity for the camera assembly 22 to move while changing focal lengths may be small. Also, digital zoom techniques may be used.

Other camera assembly 12 components may include a flash 20, a light meter 22, a display 24 for functioning as an electronic viewfinder and as part of an interactive user interface, a keypad 26 and/or buttons 28 for accepting user inputs, an optical viewfinder (not shown), and any other components commonly associated with cameras.

Another component of the camera assembly 12 may be an electronic controller 30 that controls operation of the camera assembly 12. The controller 30, or a separate circuit (e.g., a dedicated image data processor), may carry out the photograph generation. The electrical assembly that carries out the photograph generation may be embodied, for example, as a processor that executes logical instructions that are stored by an associated memory, as firmware, as an arrangement of dedicated circuit components or as a combination of these embodiments. Thus, the photograph generation technique may be physically embodied as executable code (e.g., software) that is stored on a machine readable medium or the photograph generation technique may be physically embodied as part of an electrical circuit. In another embodiment, the functions of the electronic controller 30 may be carried out by a control circuit 32 that is responsible for overall operation of the electronic device 10. In this case, the controller 30 may be omitted. In another embodiment, camera assembly 12 control functions may be distributed between the controller 30 and the control circuit 32.

In the below described exemplary embodiments of generating a digital photograph, two images that are taken with different zoom settings are used to construct the photograph. It will be appreciated that more than two images may be used. Therefore, when reference is made to images that are combined to generate a photograph, the term images explicitly refers to two images or more than two images.

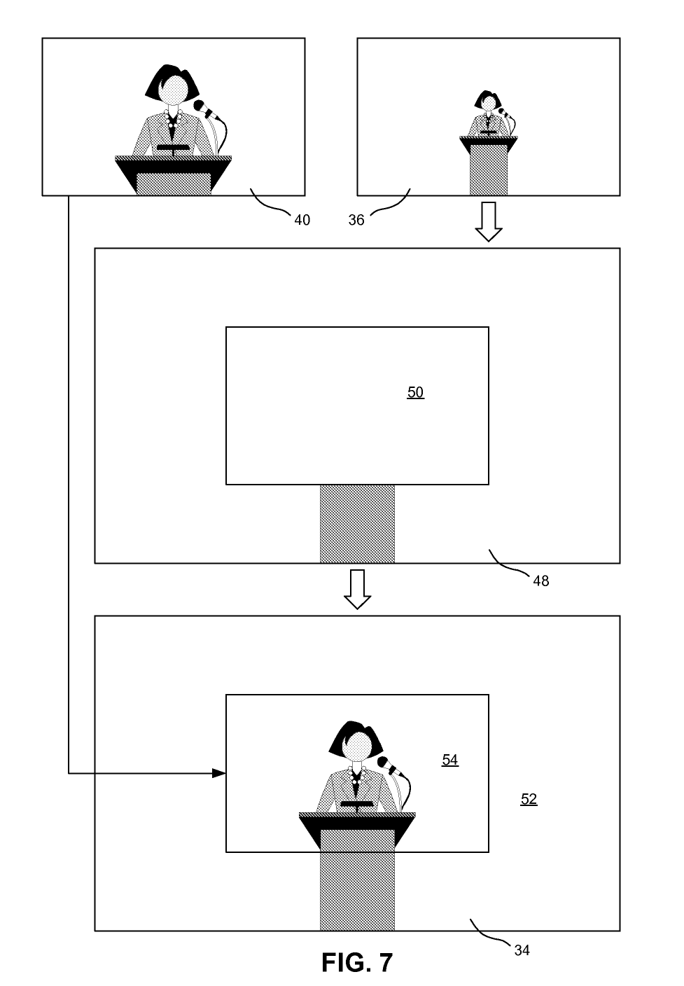

With additional reference to FIGS. 5 through 7, an exemplary technique for generating a photograph 34 includes taking a first image 36 with a first zoom setting. In particular, FIG. 5 represents taking the first image 36 of a scene 38 and FIG. 6 represents taking a second image 40 of the scene 38. FIG. 7 represents an exemplary technique for generating the photograph 34 by combining the first image 36 and the second image 40.

The first zoom setting used for capturing the first image 36 may be selected by the user as part of composing the desired photograph of a scene 38. Alternatively, the first zoom setting may be a default setting. Also, the first zoom setting has a corresponding magnification power that is less than the maximum magnification power of the camera assembly. A limit to the amount of zoom available for taking the first image 36 may be imposed to reserve greater zoom capacity for an image or images taken with greater magnification than the first image 36. In some embodiments, the first zoom setting may be about zero percent of the zoom capability of the camera assembly 12 to about fifty percent of the zoom capability of the camera assembly 12. For instance, if the camera assembly 12 is capable of magnifying the image eight times at its maximum zoom setting relative to its minimum zoom, the camera assembly 12 may be considered to have 8× zoom capability. Zero percent of the zoom capability would correspond to a 1× zoom setting of the camera assembly 12 and fifty percent of the zoom capability would correspond to a 4× zoom setting of the camera assembly 12.

The exemplary technique for generating the photograph 34 also includes taking the second image 40 with a second zoom setting where the second zoom setting has a corresponding magnification power that is more than the magnification power of the first zoom setting used to capture the first image 36. The second zoom setting may have a predetermined relationship to the first zoom setting, such as twenty to thirty percent more of the magnification power than the first zoom setting. In another embodiment, the first and second zoom settings may be based on a distance between the camera assembly 12 and an object that occupies a center area of a field of view 42 of the camera assembly 12. In some embodiments, the second zoom setting may be a maximum zoom setting of the camera assembly 12.

The two images 36 and 40 may be taken in rapid succession, preferably in a rapid enough manner so that little or no movement of objects in the scene 38 and so that little or no movement of the camera assembly 12 takes place between the image data capture for the first image 36 and the image data capture for the second image 40. The order in which the images 36 and 40 are taken is not important, but for purposes of description it will be assumed that the image taken with less zoom is taken before the image taken with more zoom.

In one embodiment, the taking of the two images 36 and 40 is transparent to the user. For instance, the user may press a shutter release button to command the taking of a desired photograph and the controller 30 may automatically control the camera assembly 12 to capture the images 36, 40 and combine the images 36, 40 as described in greater detail below. The generation of the photograph 34 in this manner may be a default manner in which photographs are generated by the camera assembly 12. Alternatively, generation of the photograph 34 in this manner may be carried out when the camera assembly 12 is in a certain mode as selected by the user.

In the illustrated embodiment, the second image 40 corresponds to a central portion 44 of the part of the scene 38 that is captured in the first image 36. For purposes of illustration, the part of the scene 38 captured in the first image 36 is shown with a dashed line 46 in FIG. 6. In effect, the zoom setting for the second image 40 narrows the field of the view 42 of the camera assembly 12 relative to the field of view 42 of the camera assembly 12 when configured to take the first image 36. But, in the illustrated embodiment, both the first image 36 and the second image 40 are centered on approximately the same spot in the scene 38. It is possible that the second image 40 may be centered on a different spot in the scene 38 than the first image 36. For example, pattern recognition may be used to identify a predominate face in the scene 36 where the face is off-center in the first image 36 and the second image 40 may be taken to be centered on the face. In this example, the second image 40 narrows the field of the view 42 relative to the first image 36 and shifts the center spot of the second image 40 with respect to the center spot of the first image 36 (e.g., the second image 40 is panned with respect to the first image 36).

As will be appreciated, by virtue of the fact that the second image 40 has higher magnification than the first image 36, the second image 40 will have a higher pixel density per unit area of the imaged scene 38 than the first image 36. Therefore, when the image data for the second image 40 is compared to the image data for the first image 36, the image data for the second image 40 will have higher density of image information per unit area of the scene 38 than the first image 36.

In one embodiment, each image 36, 40 may have the same (or comparable) resolution in terms of number of pixels per unit area of the image 36, 40 and the same (or comparable) size in terms of the number of horizontal and vertical pixels. But the separation between adjacent pixels of the first image 36 may represent more area of the scene 38 than the separation between adjacent pixels of the second image 40.

With additional reference to FIG. 7, an embodiment of merging the images 36, 40 together is shown. In this embodiment, the first image may be up-sampled to match the images 36, 40 for purposes of merging. As used herein, the term “up-sampling” includes at least adding samples (e.g., pixels) and, in addition to adding samples, the term “up-sampling” may include filtering the image data.

For instance, in the embodiment of FIG. 7, the first image 36 is up-sampled to add space between the pixels of the first image so that a scale area of the scene represented by the separation between adjacent pixels of the first image 36 matches a scale area of the scene represented by the separation between adjacent pixels of the second image 40. The term “scale area” refers to an area of the scene that has been normalized to account for variations in distance between the camera assembly 12 and objects in the image field.

The amount of up-sampling of the first image 36 may be based on focal length information corresponding to each of the images 36, 40 and/or solid angle information of the field of view of the camera assembly 12 at the corresponding zoom settings. More particularly, for each zoom setting, a corresponding focal length and/or solid angle of the camera assembly 12 may be known to the controller 30 or may be calculated. The second image 40 will correspond to a longer focal length than the first image 36 and the second image 40 will correspond to a smaller solid angle than the first image 36. Using the focal length and/or solid angle corresponding to each of the images 36, 40, the first image 36 may be up-sampled to coordinate with the second image 40. In addition, or in the alternative, the images 36, 40 may be analyzed for common points in the scene and the first image 36 may be up-sampled based on a scale relationship between the points in the first image 36 to the corresponding points in the second image 40. In another approach, the up-sampling may be based on a frame size of the second image 40 so that a frame size of the up-sampled first image 36 is large enough so that the portion of the scene represented by the second image 40 overlaps the same portion of the scene as represented by the up-sampled first image. In sum, the first image 36 may be up-sampled by an amount so that the second image 40 may be registered into alignment with the first image 36.

In the up-sampling operation, pixel size may not be changed. Rather, space may be created between pixels, which is filled by adding pixels between the original pixels of the first image 36 to create an interim image 48. The number and placement of added pixels may be controlled so that when the interim image 48 and the second image 40 may have coordinating pixel pitches in the vertical and horizontal directions to facilitate combining of the images 40, 48. The added pixels may be populated with information by “doubling-up” pixel data (e.g., copying data from an adjacent original pixel and using the copied data for the added pixel), by interpolation to the resolution dictated by the second image 40, or by any other appropriate technique. As indicated, filtering may be used and the filtering may lead to populating the image data of the added pixels. Since the image data for the up-sampling is derived from existing image data, no new image data may be added when carrying out the up-sampling. As such, the image data for the original pixels and the added pixels may be efficiently compressed depending on the applied compression technique.

Next, the image data for the second image 40 may be stitched with the image data for the interim image 48. For example, the image data for the second image 40 may be mapped to the image data for the interim image 48. In one embodiment, image stitching software may be used to correlate points in the second image 40 with corresponding points in the interim image 48. One or both of the images 40, 48 may be morphed (e.g., stretched) so that the corresponding points in the two images align. Image stitching software that creates panoramic views from plural images that represent portions of a scene that are laterally and/or vertically adjacent one another may be modified to accomplish these tasks.

Once the images are aligned, the interim image 48 may be cropped to remove a portion 50 of the interim image 48 that corresponds to the portion of the scene 38 represented in the second image 40. Then, the removed image data may be replaced with image data from the second image 40 such that the edges of the second image 40 are registered to edges of the removed portion 50. In some embodiments, one or more perimeter edges of the second image 40 may be cropped as part of this image merging processing. If perimeter cropping of the second image 40 is made, the removed portion 50 of the interim image 40 may be sized to correspond to the cropped second image rather than the entire second image 40.

As a result of this image merging process, the photograph 34 is generated. The photograph may have a frame size that is different from the original frame sizes of the first and second images. Also, the photograph 34 has a perceptually low-quality component 52 and a perceptually high-quality component 54 when the relative perceptual qualities are measured as a function of an amount of original image data per unit area of the scene 38 or as a function of an amount of original image data per unit area of the photograph 34. The low-quality component 52 corresponds to image data from the first image 36 and the high-quality component 54 corresponds to image data from the second image 40. In this way, the photograph 34 has increased perceptual quality in a portion of the image field than compared to the conventional approach of generating a photograph by capturing image data once. Also, an image file used to store the photograph 34 may have a reasonable file size. For instance, the file size may be larger than the file size for the second image 40, but smaller than the combination of the file size of the second image 40 and the file size of the first image 36. It is also possible that the image file for the photograph 34 will consume less memory than a photograph generated by taking one image of the same portion of the scene at the same effective resolution as the resolution of the high-quality image component 54.

In addition to perceptual quality or instead of perceptual quality, quality of the photograph 34 (and differences in quality across the photograph 34) may be measured in other ways. For example, the quality may be quantified in terms of a metric, such as peak signal-to-noise ratio (PSNR) or average PSNR.

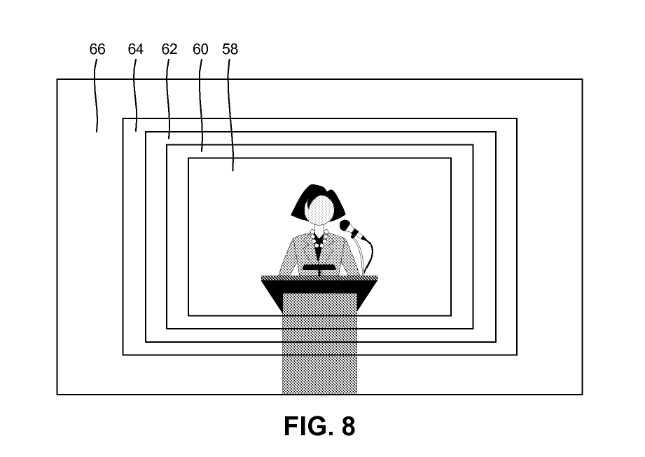

The line present in FIG. 7 that separates the components 52 and 54, and the similar lines in FIG. 8, is shown for illustration purposes to depict the demarcation between perceptual quality levels. It will be appreciated that the actual photograph 34 generated using one of the described techniques will not contain a visible line.

Another technique for generating the photograph 34 by combining the first image 36 and the second image 40 may include capturing the first image 36 and second image 40 as described above. Then, the second image 40 may be down-sampled or, alternatively, the second image 40 may be down-sampled and the first image 36 may be up-sampled. As used herein, the term “down-sampling” includes at least removing samples (e.g., pixels) and, in addition to removing samples, the term “down-sampling” may include the filtering image data. For instance, the image data may be filtered with a low pass filter to increase the number of bits per pixel (e.g., from six bits per pixel before down-sampling to eight bits per pixel after down-sampling). Thus, the down-sampling, when it includes filtering, may reduce or eliminate information loss over an operation that just removes samples. The amount of down-sampling may be determined by any appropriate technique, such as the techniques described above for determining the amount of up-sampling for the embodiment of FIG. 7.

After down-sampling, a portion 50 of the first image 36 (or up-sampled first image) may be removed to accommodate the down-sampled second image and the down-sampled second image may be merged with (e.g., stitched into) the first image 36 (or up-sampled first image) to generate the photograph 34.

This approach may result in a resultant image that has higher PSNR than at least the first image 36 due to an availability of more information per unit area of the scene 38 to work with in the second image 40 than in the first image 36. Therefore, if quality of the photograph 34 that is generated using a down-sampled second image 40 is measured as a function of PSNR or average PSNR, the photograph 34 has the potential to have improved quality versus at least the original first image 36.

By generating the photograph 34 in accordance with at least one of the disclosed approaches, the photograph 34 includes the desired portion of the scene 38 that the user framed to be in the field of view of the camera assembly 12. In one embodiment, after the photograph 34 has been generated, the photograph 34 may be compressed using any appropriate image compression technique and/or down-sampled using any appropriate down-sampling technique to reduce the file size of the corresponding image file.

With additional reference to FIG. 8, illustrated is an embodiment of the photograph 34 that has been generated using more than two images. In the illustrated embodiment, five images that were each taken with progressively increasing zoom settings are used in the generation of the photograph 34. The images are progressively nested within one another to generate a graduation to the quality of the photograph 34. In other words, an image 58 taken with the longest focal length (highest magnification) is surrounded by a portion of an image 60 taken with the next to longest focal length. The image 60 is, in turn, surrounded by a portion of an image 62 taken with the middle focal length of the group of images. The image 62 is, in turn, surrounded by a portion of an image 64 taken with the next to shortest focal length and the image 64 is surrounded by a portion of an image 66 taken with the shortest focal length.

When more than two images are used to generate the photograph 34, the photograph 34 may be constructed in steps. For instance, two of the images may be selected, one of the two selected images may be up-sampled (or down-sampled), a portion of the images taken with less zoom may be removed and the two images may be stitched together to create an intermediate image. The process may be repeated using the intermediate image and another of the images. In another embodiment, all of the images or all but one of the images may be up-sampled and/or down-sampled, and the images may be simultaneously stitched together.

When more than two images are used to generate the photograph 34, all of the images may have the same center spot as is depicted in the embodiment of FIG. 8. In another embodiment, at least two of the images may have center spots that are different than the other images. For instance, using pattern recognition, two faces may be identified in the scene. A first image may be used to capture the scene with relatively low zoom, a second image may be used to capture the first identified face with relatively high zoom and the third image may be used to capture the second identified face with relatively high zoom. The zoom settings associated with the second and third images may be the same or different.

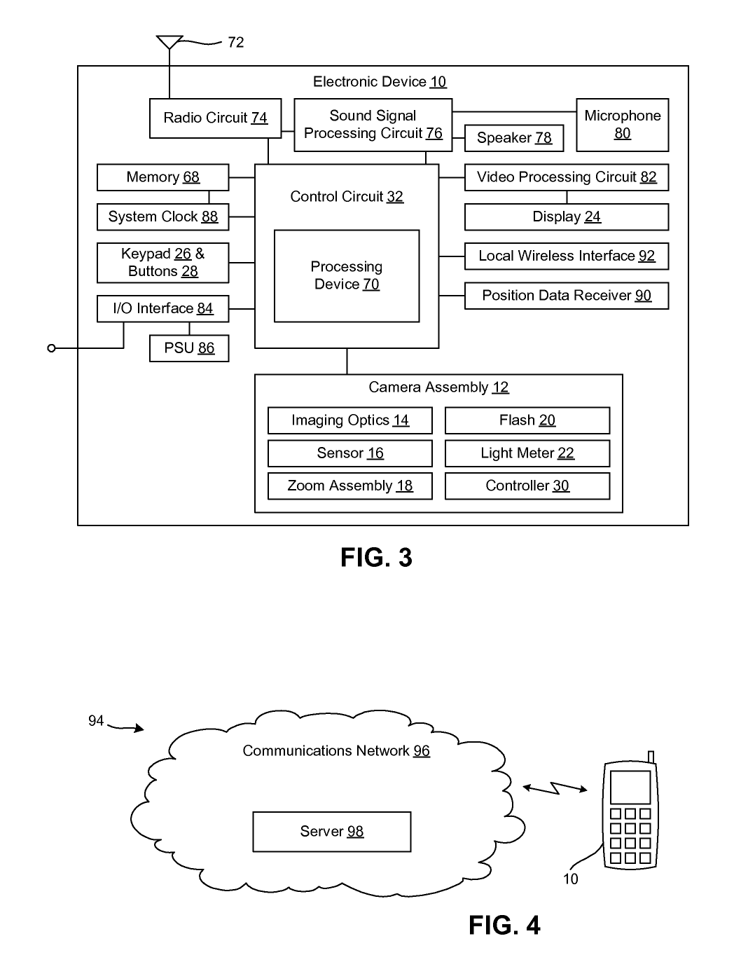

As indicated, the illustrated electronic device 10 shown in FIGS. 1 and 2 is a mobile telephone. Features of the electronic device 10, when implemented as a mobile telephone, will be described with additional reference to FIG. 3. The electronic device 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

As indicated, the electronic device 10 may include the display 24. The display 24 displays information to a user such as operating state, time, telephone numbers, contact information, various menus, etc., that enable the user to utilize the various features of the electronic device 10. The display 24 also may be used to visually display content received by the electronic device 10 and/or retrieved from a memory 68 of the electronic device 10. The display 24 may be used to present images, video and other graphics to the user, such as photographs, mobile television content and video associated with games.

The keypad 26 and/or buttons 28 may provide for a variety of user input operations. For example, the keypad 26 may include alphanumeric keys for allowing entry of alphanumeric information such as telephone numbers, phone lists, contact information, notes, text, etc. In addition, the keypad 26 and/or buttons 28 may include special function keys such as a “call send” key for initiating or answering a call, and a “call end” key for ending or “hanging up” a call. Special function keys also may include menu navigation and select keys to facilitate navigating through a menu displayed on the display 24. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, etc. Keys or key-like functionality also may be embodied as a touch screen associated with the display 24. Also, the display 24 and keypad 26 and/or buttons 28 may be used in conjunction with one another to implement soft key functionality. As such, the display 24, the keypad 26 and/or the buttons 28 may be used to control the camera assembly 12.

The electronic device 10 may include call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 68, executing applications to allow user interaction with the data, displaying video and/or image content associated with the data, outputting audio sounds associated with the data, and so forth.

The electronic device 10 may include the primary control circuit 32 that is configured to carry out overall control of the functions and operations of the electronic device 10. As indicated, the control circuit 32 may be responsible for controlling the camera assembly 12, including the resolution management of photographs.

The control circuit 32 may include a processing device 70, such as a central processing unit (CPU), microcontroller or microprocessor. The processing device 70 may execute code that implements the various functions of the electronic device 10. The code may be stored in a memory (not shown) within the control circuit 32 and/or in a separate memory, such as the memory 68, in order to carry out operation of the electronic device 10. It will be apparent to a person having ordinary skill in the art of computer programming, and specifically in application programming for mobile telephones or other electronic devices, how to program a electronic device 10 to operate and carry out various logical functions.

Among other data storage responsibilities, the memory 68 may be used to store photographs 34 that are generated by the camera assembly 12. Images used to generate the photographs 34 may be temporarily stored by the memory 68. Alternatively, the images and/or the photographs 34 may be stored in a separate memory. The memory 68 may be, for example, one or more of a buffer, a flash memory, a hard drive, a removable media, a volatile memory, a non-volatile memory, a random access memory (RAM), or other suitable device. In a typical arrangement, the memory 68 may include a non-volatile memory (e.g., a NAND or NOR architecture flash memory) for long term data storage and a volatile memory that functions as system memory for the control circuit 32. The volatile memory may be a RAM implemented with synchronous dynamic random access memory (SDRAM), for example. The memory 68 may exchange data with the control circuit 32 over a data bus. Accompanying control lines and an address bus between the memory 68 and the control circuit 32 also may be present.

Continuing to refer to FIGS. 1 through 3, the electronic device 10 includes an antenna 72 coupled to a radio circuit 74. The radio circuit 74 includes a radio frequency transmitter and receiver for transmitting and receiving signals via the antenna 72. The radio circuit 74 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 72 and the radio circuit 74 may represent one or more than one radio transceivers.

The electronic device 10 further includes a sound signal processing circuit 76 for processing audio signals transmitted by and received from the radio circuit 74. Coupled to the sound processing circuit 76 are a speaker 78 and a microphone 80 that enable a user to listen and speak via the electronic device 10 as is conventional. The radio circuit 74 and sound processing circuit 76 are each coupled to the control circuit 32 so as to carry out overall operation. Audio data may be passed from the control circuit 32 to the sound signal processing circuit 76 for playback to the user. The audio data may include, for example, audio data from an audio file stored by the memory 68 and retrieved by the control circuit 32, or received audio data such as in the form of streaming audio data from a mobile radio service. The sound processing circuit 76 may include any appropriate buffers, decoders, amplifiers and so forth.

The display 24 may be coupled to the control circuit 32 by a video processing circuit 82 that converts video data to a video signal used to drive the display 24. The video processing circuit 82 may include any appropriate buffers, decoders, video data processors and so forth. The video data may be generated by the control circuit 32, retrieved from a video file that is stored in the memory 68, derived from an incoming video data stream that is received by the radio circuit 74 or obtained by any other suitable method. Also, the video data may be generated by the camera assembly 12 (e.g., such as a preview video stream to provide a viewfinder function for the camera assembly 12).

The electronic device 10 may further include one or more I/O interface(s) 84. The I/O interface(s) 84 may be in the form of typical mobile telephone I/O interfaces and may include one or more electrical connectors. As is typical, the I/O interface(s) 84 may be used to couple the electronic device 10 to a battery charger to charge a battery of a power supply unit (PSU) 86 within the electronic device 10. In addition, or in the alternative, the I/O interface(s) 84 may serve to connect the electronic device 10 to a headset assembly (e.g., a personal handsfree (PHF) device) that has a wired interface with the electronic device 10. Further, the I/O interface(s) 84 may serve to connect the electronic device 10 to a personal computer or other device via a data cable for the exchange of data. The electronic device 10 may receive operating power via the I/O interface(s) 84 when connected to a vehicle power adapter or an electricity outlet power adapter. The PSU 86 may supply power to operate the electronic device 10 in the absence of an external power source.

The electronic device 10 also may include a system clock 88 for clocking the various components of the electronic device 10, such as the control circuit 32 and the memory 68.

The electronic device 10 also may include a position data receiver 90, such as a global positioning system (GPS) receiver, Galileo satellite system receiver or the like. The position data receiver 90 may be involved in determining the location of the electronic device 10.

The electronic device 10 also may include a local wireless interface 92, such as an infrared transceiver and/or an RF interface (e.g., a Bluetooth interface), for establishing communication with an accessory, another mobile radio terminal, a computer or another device. For example, the local wireless interface 92 may operatively couple the electronic device 10 to a headset assembly (e.g., a PHF device) in an embodiment where the headset assembly has a corresponding wireless interface.

With additional reference to FIG. 4, the electronic device 10 may be configured to operate as part of a communications system 94. The system 94 may include a communications network 96 having a server 98 (or servers) for managing calls placed by and destined to the electronic device 10, transmitting data to the electronic device 10 and carrying out any other support functions. The server 98 communicates with the electronic device 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 96 may support the communications activity of multiple electronic devices 10 and other types of end user devices. As will be appreciated, the server 98 may be configured as a typical computer system used to carry out server functions and may include a processor configured to execute software containing logical instructions that embody the functions of the server 98 and a memory to store such software.

Although certain embodiments have been shown and described, it is understood that equivalents and modifications falling within the scope of the appended claims will occur to others who are skilled in the art upon the reading and understanding of this specification.

What is claimed is:

1. A method of generating a photograph with a digital camera, comprising:
capturing a first image of a scene with a first zoom setting;
capturing a second image of the scene with a second zoom setting, the second zoom setting corresponding to higher magnification than the first zoom setting;
up-sampling the first image to generate an interim image; and
stitching the second image into the interim image in place of a removed portion of the interim image that corresponds to a portion of the scene represented by the second image such that the stitched image is the photograph, the photograph having higher perceptual quality in a region corresponding to image data of the second image than in a region corresponding to image data of the first image.

2. The method of claim 1, wherein the first image corresponds to a field of view of the camera that is composed by a user of the camera.

3. The method of claim 1, wherein up-sampling of the first image includes filtering image data of the first image.

4. The method of claim 1, wherein the first image and the second image have substantially the same center spot with respect to the scene.

5. The method of claim 1, wherein a center spot of the second image is shifted with respect to a center spot of the first image.

6. The method of claim 5, further comprising using pattern recognition to identify an object in the scene and the center spot of the second image is centered on the object.

7. The method of claim 6, wherein the recognized object is a face.

8. The method of claim 1, wherein the first and the second images are captured in rapid succession to minimize changes in the scene between capturing the first image and capturing the second image.

9. The method of claim 1, further comprising:
capturing at least one additional image, where each additional image is captured with a zoom setting different than the first zoom setting; and
combining each additional image with the first and second images so that the photograph has quality regions that correspond to image data from each image.

10. The method of claim 9, wherein each image has substantially the same center spot with respect to the scene.

11. The method of claim 10, wherein the zoom setting associated with each image is different than every other zoom setting.

12. The method of claim 9, wherein at least two of the images have corresponding center spots that differ from the rest of the images.

13. A camera assembly for generating a digital photograph, comprising:
a sensor for capturing image data;
imaging optics for focusing light from a scene onto the sensor, the imaging optics being adjustable to change a zoom setting of the camera assembly; and
a controller that controls the sensor and the imaging optics to capture a first image of a scene with a first zoom setting and a second image of the scene with a second zoom setting, the second zoom setting corresponding to higher magnification than the first zoom setting, wherein the controller:
up-samples the first image to generate an interim image; and
stitches the second image into the interim image in place of a removed portion of the interim image that corresponds to a portion of the scene represented by the second image such that the stitched image is the photograph, the photograph having higher perceptual quality in a region corresponding to image data of the second image than in a region corresponding to image data of the first image.

14. The camera assembly of claim 13, wherein the first image corresponds to a field of view of the camera assembly that is composed by a user of the camera assembly.

15. The camera assembly of claim 13, wherein up-sampling of the first image includes filtering image data of the first image

16. The camera assembly of claim 13, wherein the first image and the second image have substantially the same center spot with respect to the scene.

17. The camera assembly of claim 13, wherein a center spot of the second image is shifted with respect to a center spot of the first image.

18. The camera assembly of claim 17, wherein pattern recognition is used to identify an object in the scene and the center spot of the second image is centered on the object.

19. The camera assembly of claim 13, wherein the first and the second images are captured in rapid succession to minimize changes in the scene between capturing the first image and capturing the second image.

20. The camera assembly of claim 13, wherein the controller controls the sensor to capture at least one additional image, where each additional image is captured with a zoom setting different than the first zoom setting and the controller combines each additional image with the first and second images so that the photograph has quality regions that correspond to image data from each image.

21. The camera assembly of claim 13, wherein the camera assembly forms part of a mobile telephone that establishes a call over a network.

22. A method of generating a photograph with a digital camera, comprising:
capturing a first image of a scene with a first zoom setting;
capturing a second image of the scene with a second zoom setting, the second zoom setting corresponding to higher magnification than the first zoom setting;
down-sampling the second image to generate an interim image; and
stitching the interim image into the first image in place of a removed portion of the first image that corresponds to a portion of the scene represented by the interim image such that the stitched image is the photograph.

23. The method of claim 22, wherein the first image corresponds to a field of view of the camera that is composed by a user of the camera.

24. The method of claim 22, wherein down-sampling of the second image includes filtering image data of the second image.

25. The method of claim 22, further comprising:
capturing at least one additional image, where each additional image is captured with a zoom setting different than the first zoom setting; and
combining each additional image with the first and second images so that the photograph has regions that correspond to image data from each image.
